(19) United States
(12) Patent Application Publication
(10) Pub. No.: US 2022/0060803 A1
(43) Pub. Date: Feb. 24, 2022

(54) SYSTEMS, APPARATUS, AND METHODS OF VIDEO AFFILIATE CONTENT LINKING

(71) Applicant: GraphicSoft LLC, Provo, UT (US)

(72) Inventor: John Wright, Provo, UT (US)

(21) Appl. No.: 17/445,194

(22) Filed: Aug. 16, 2021

Related U.S. Application Data
(60) Provisional application No. 62/706,487, filed on Aug. 19, 2020.

(51) Int. Cl. H04N 21/858; H04N 21/8545; H04N 5/06; H04N 21/81

(52) U.S. Cl. CPC H04N 21/8583; H04N 21/812; H04N 5/06; H04N 21/8545

(57) ABSTRACT

An affiliate linking system may create affiliate video data that causes a clickable graphical object to be rendered overlaid on video content. The clickable graphical object may include an affiliate link that when accessed, gains credit for a lead generated by the act of accessing the computing resource indicated by the link. The clickable graphical object may be synchronized to a timeframe within the video to coincide with actions or objects within the video. The affiliate video data that causes video content to be overlaid with an affiliate layer can be shared via social media, email, text, or other communication methods.

### RELATED APPLICATIONS

This application claims priority to and the benefit of U.S. Provisional Patent Application No. 62/706,487, filed Aug. 18, 2020, which is hereby incorporated by reference herein in its entirety.

### TECHNICAL FIELD

The present disclosure relates to video rendering and more specifically to affiliate linking in synchronization with video content.

### BACKGROUND

A company may provide a tracking code or affiliate code to an affiliate marketer. The affiliate marketer may use the tracking code or affiliate code to link to products of the company. For example, an affiliate marketer may describe a product and then link to a product with a URL and the tracking code appended to the URL. When a viewer clicks on the link, the viewer may be presented with an opportunity to buy the product and the affiliate marketer may receive a reward from the company for the viewer as a lead.

### BRIEF DESCRIPTION OF THE DRAWINGS

FIG. 1 shows a diagram illustrating affiliate video data.

FIG. 2 shows a diagram illustrating a video affiliate content linking system.

FIG. 3 shows a diagram illustrating a video affiliate content linking system.

FIG. 4 shows a flowchart of a method for video affiliate content linking.

FIG. 5 is a block diagram illustrating a computing system and components.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Techniques, apparatus and methods are disclosed that enable a user to create a clickable graphical object on a layer above video content. The clickable graphical object may include an affiliate link (e.g., a hyperlink with affiliate parameter, an API call with affiliate tracking, etc.) to gain credit for a lead generated by accessing a computing resource indicated by the link. The clickable graphical object may be synchronized to a timeframe within the video to coincide with actions or objects within the video. The video with the affiliate layer can be shared via social media, email, text or other communication methods.

In some embodiments, a video may contain multiple clickable graphical objects with affiliate links. An affiliate link may coincide with a specific time frame in a video. This may allow an affiliate video creator to advertise more than one product in a single video and get credit for product links separately. A graphical object may comprise data describing rendering information including shape information, picture information, color information, etc.

Social media marketing allows individuals to recommend products to other individuals. Some individuals build businesses based on advertising products to people within their social media influence. In some cases, people recommend products that may be directly purchased by them. Others may recommend products through sharing a link to products. These links may contain an affiliate tracking code. The affiliate tracking code may be used by an affiliate tracking system to give credit (e.g., money, points, prizes, or other value) to whom the affiliate tracking code belongs.

While links may be easily embedded into text through hyperlinks, text does not appear to be as effective method of gaining attention on social media. A photo may be better than text and may be linked. Video appears to be more successful in social media campaigns. People may not take the time to read text below the video and/or click on hyperlinks within that description text. People may see the products in the video and then search in a search engine for the product. If a viewer searches in a search engine for a product, the viewer will not be using an affiliate link from the creator of the social media video campaign and the creator will not get credit through their affiliate link.

A creator may share a video that includes a clickable shape overlaid on top of video content. The clickable shape may identify products or services within the video. The display and/or activation clickable shape may be synchronized to timing within the video. The clickable shape may include a link with affiliate code to a product or service. A viewer may click, tap, or otherwise request a resource identified by the clickable link. The creator of the video content with clickable shape may receive value from a company for a product or service that granted the affiliate code.

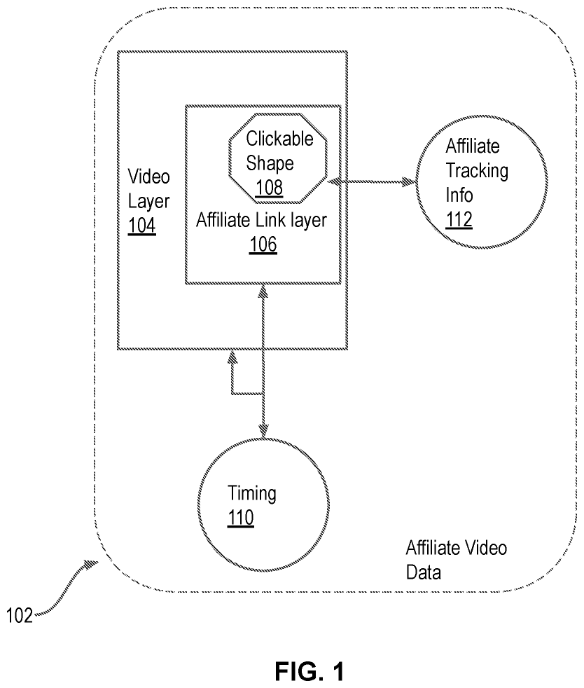

FIG. 1 shows a diagram illustrating affiliate video data 102. Affiliate video data 102 may comprise video data and affiliate data that describe a video layer 104, an affiliate link layer 106, graphical or clickable shape 108 information, affiliate tracking information 112, and/or timing information 110). Graphical information (e.g., a clickable shape 108) may be presented in the affiliate link layer 106 that overlays the video layer 104 based on a synchronization defined in the timing information 110. Clickable shape 108 information may include polygon information, vertex information, drawing information, etc.

The affiliate video data may comprise video data for rendering to a video layer 104 and affiliate data describing an affiliate link layer 106, clickable shape 108 information, affiliate tracking information 112, and/or timing information 110. The video layer 104 may be overlaid by an affiliate link layer 106 that comprises a clickable shape 108. The clickable shape 108. may comprise definitions of the shape (e.g., coordinates, color, text, etc.) and link information (e.g., URL, tracking code, cookie, computing resource location, requirements, etc.). The video layer 104 and clickable shape 108 may be synchronized to enable the clickable shape 108. to appear during one or more timeframes of the video presentation. These timeframes may comprise indications when objects, speech, or other indications of a service or product are presented, and/or other impactful moments (e.g., emotional appeals, factual appeals, colors, dialog, etc.). The timing information 110 may be based on actual time, run time, frame number, time elapsed since start, frame information or other relationship to a value.

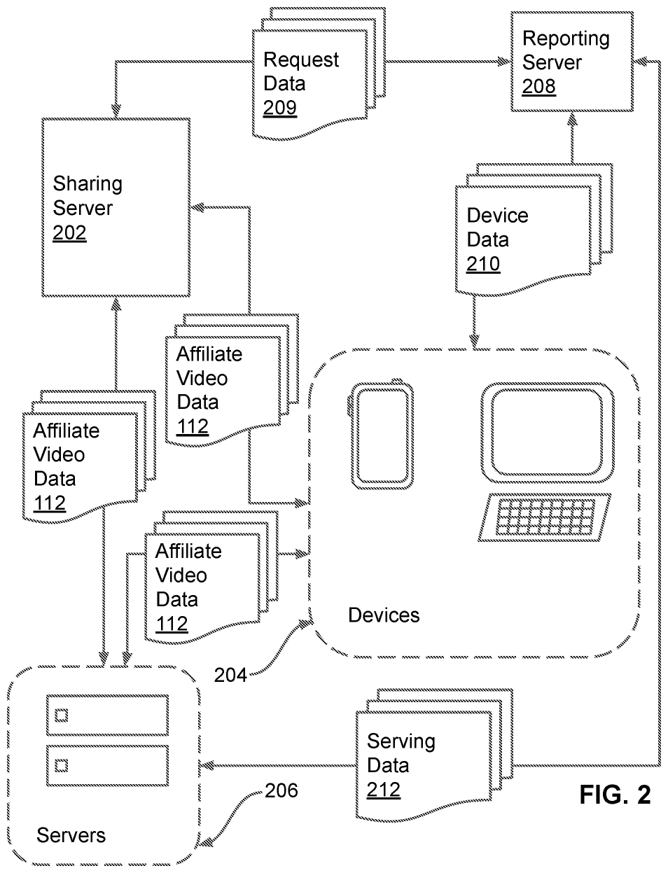

FIG. 2 shows a diagram illustrating video affiliate content linking. The affiliate video data 102 may be provided to a sharing system 202 that presents the affiliate video data 102 or an indication of the affiliate video data (e.g., a link to the video data, a URL to the video data, etc.) to other devices 204 via communications (e.g., API, messaging, request/response, etc.). The affiliate video data 102 may comprise tracking information that may be used in reporting use or presentation of the affiliate video data and/or affiliate marketing information (e.g., use of an affiliate marketing link).

A sharing system 202 may receive and/or create the affiliate video data and prepare for viewing and/or transmission to devices 204 or servers 206 (e.g., sending to content delivery networks, storing it at a storage location identified by a URL, transmitting to social networking services, etc.). The sharing system 202 may provide the affiliate video data 102 to APIs, via messages, or other transmission methods to servers 206 and/or devices 204. The sharing system 202 may also provide additional information for sharing, including account information, advertising information, payment information and/or other information as a part of or in addition to the transmission of affiliate video data 102. For example, the sharing system 202 may transmit the affiliate video data 102 and account information via an API to a social media server 206. The social media server 206 may publish the affiliate video data 102 and/or provide the affiliate video data 102 via feed to social connections of the account via applications executing on devices 204 (e.g., mobile application, browser, etc.).

A reporting system 208 (e.g., analytics system, artificial intelligence system, business intelligence system, etc.) may receive information related to the transmission, viewing, linking from, and/or sharing of the affiliate video data 102. The reporting system 208 may receive and/or monitor request data 209 (e.g., receive information from the sharing system regarding transmission, reach and/or other sharing data of the affiliate video data). The reporting system 208 may receive device data 210 from computing resources receiving and/or displaying the affiliate video data (e.g., decryption key request, ping, cookie, etc.). The reporting system 208 may receive serving data 212 from servers 206 (e.g., a provider regarding tracking code usage, affiliate credit, purchases, leads provided, etc.). The reporting system 208 may provide data to another system and/or provide reports via an affiliate marketing account.

For example, an affiliate marketer may sign up for an account at a provider. The provider may present the affiliate marketer with a tracking code for use in referrals to goods and/or services provided by a provider. The affiliate marketer may create a video showing a person doing a workout in clothing including pants and a top. The affiliate marketer may create a first clickable shape comprising the tracking code and a first link to a first webpage of a provider that offers the pants for sale. The first clickable shape may be configured to display during the first half of the video. The affiliate marketer may create a second clickable shape comprising the tracking code and a second link to a second webpage of a provider that offers the top for sale. The second clickable shape may be configured to display during the second half of the video. The affiliate marketer may cause the video, first clickable shape, second clickable shape, and timing information to be encapsulated in or associated together as affiliate video data.

In some embodiments, the video data and affiliate data are stored separately. However, even when stored separately, they are referred to herein as affiliate video data. In other embodiments, the video data and affiliate data are stored together (e.g., via encapsulation, JavaScript Object Notation (JSON), etc.).

The affiliate video data 102 may be provided to social media servers 206 with an indication to share the affiliate video data 102 with connections of an account of the social media system. One or more viewers may view the affiliate video data 102. Views of the affiliate video data 102 may be recorded by the social media system and/or a reporting system 208 (e.g., through an external request, link, transparent pixel, etc.). Selection (e.g., activation, clicking on, touching, or any form of indicating use of the link) of the link may cause the viewer to be presented with information from/about/directed by the provider, and/or cause credit for the affiliate marketer to be recorded based on a tracking indication associated with (e.g., within an URL, as part of a cookie, etc.) the affiliate marketer.

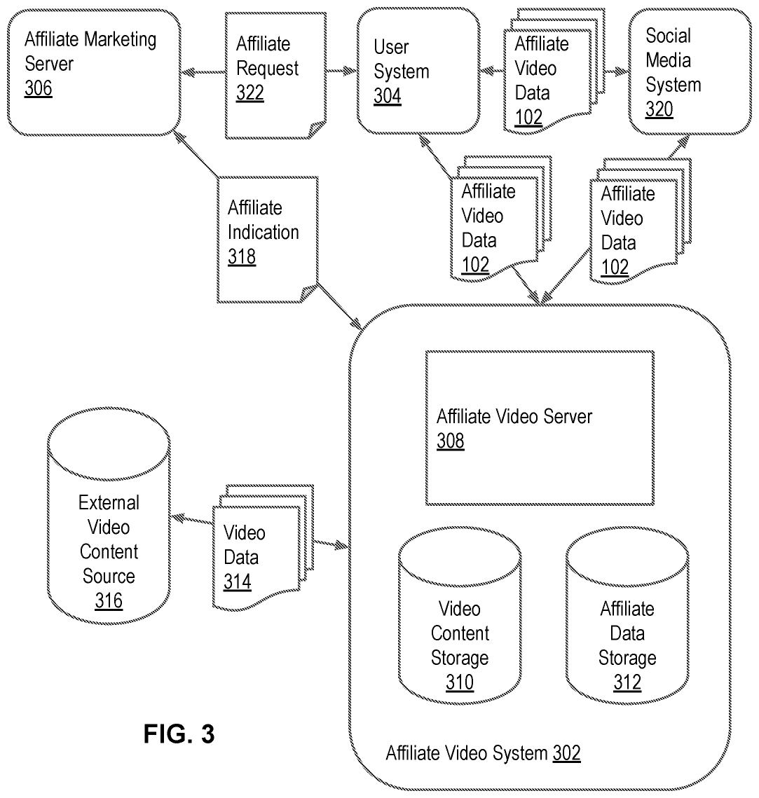

FIG. 3 shows a diagram illustrating a video affiliate content linking system. An affiliate video system 302 may communicate with a user system 304, affiliate marketing server 306, and/or systems that store video content. The affiliate video system 302 may comprise one or more affiliate video servers 308, one or more video content storage 310 and/or one or more affiliate data storage 312. The affiliate video server 308 may create and/or provide affiliate video data 102 as described in FIG. 1. The affiliate video server 308 may combine video data 314 from video content storage and affiliate data from affiliate data storage to create the affiliate video data 102 as described in FIG. 1.

The affiliate video system 302 may request and/or receive video data 314 from external video content sources 316 (e.g., local filesystems, online filesystems, online content storage, online video providers, etc.). The affiliate video system 302 may receive an affiliate indication 318 from an affiliate marketing server 306 (e.g., from a provider of goods or services, a marketing company, etc.). The affiliate indication 318 may comprise an affiliate tracking code, identifier, URL, key, indication of a webpage, indication of an application location, indication of an application link, etc. The affiliate video system 302 may alternatively receive the affiliate indication 318 and/or tracking code from input provided by the affiliate marketer and/or user.

The affiliate video system 302 may combine data within the service (e.g., affiliate indication 318, video data 314, affiliate data) to form affiliate video data 102. The affiliate video system 302 may provide affiliate video data 102 or indication of affiliate video data directly to a user system 304 (e.g., email, text, etc.) or to a social media system 320 that then provides the affiliate video data to a user system 304 (e.g., through notification, feed, etc.). The user system 304 and/or social media system 320 may report back views and/or other statistics regarding the use or providing of the affiliate video data 102 to the user system. The user system 304 may receive a user request to follow or access a link within the affiliate video data 102 (e.g., a URL with a tracking code, etc.). The user system 304 may retrieve the information from the affiliate marketing server 306 with an affiliate request 322 (e.g., a request identifying the affiliate, a request indicating the affiliate, etc.) for a provider website, app data, etc. and/or provide the tracking information. The affiliate marketer account may receive credit for the user system access based on the provided tracking code. The affiliate marketing server 306, etc. may report the credit received by the affiliate marketer account to the affiliate video system.

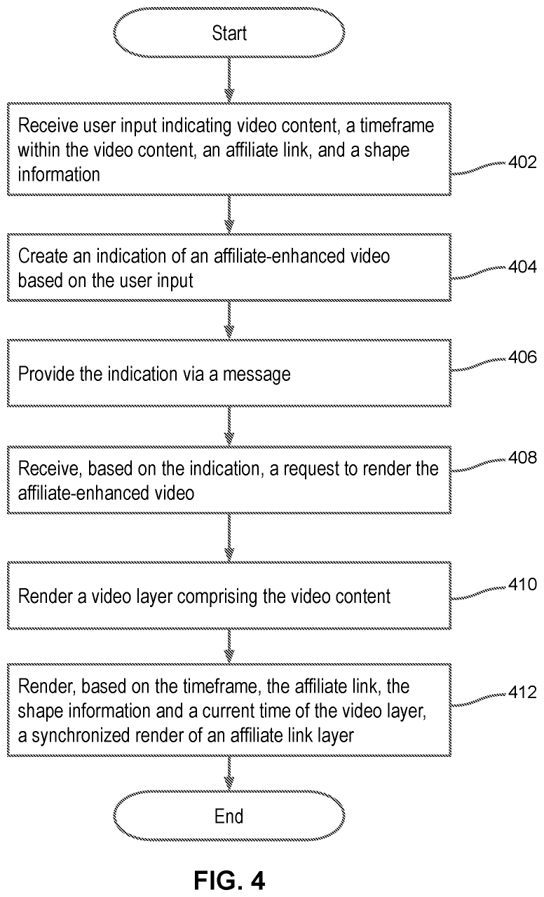

FIG. 4 shows a flowchart of a method for video affiliate content linking. The method may be performed by systems and/or components described herein, including the affiliate video system from FIG. 3. In block 402, the affiliate video system may receive user input indicating video content, a timeframe within the video content, an affiliate link, and shape information. The affiliate video system may create affiliate video data comprising the video content, the timeframe, the affiliate link, and the shape information. In block 404, the affiliate video system may create an indication (e.g., URL, etc.) of an affiliate-enhanced video based on the user input. In block 406, the affiliate video system may provide the indication to a device via a message. In block 408, the affiliate video system may receive, based on the indication and from the device, a request to send affiliate video data representing the affiliate-enhanced video to the device. In block 410, the device may receive the affiliate video data and may render a video layer comprising the video content. In block 412, the device may render, based on the timeframe, the affiliate link, the shape information and a current time of the video layer, a synchronized render of an affiliate link layer.

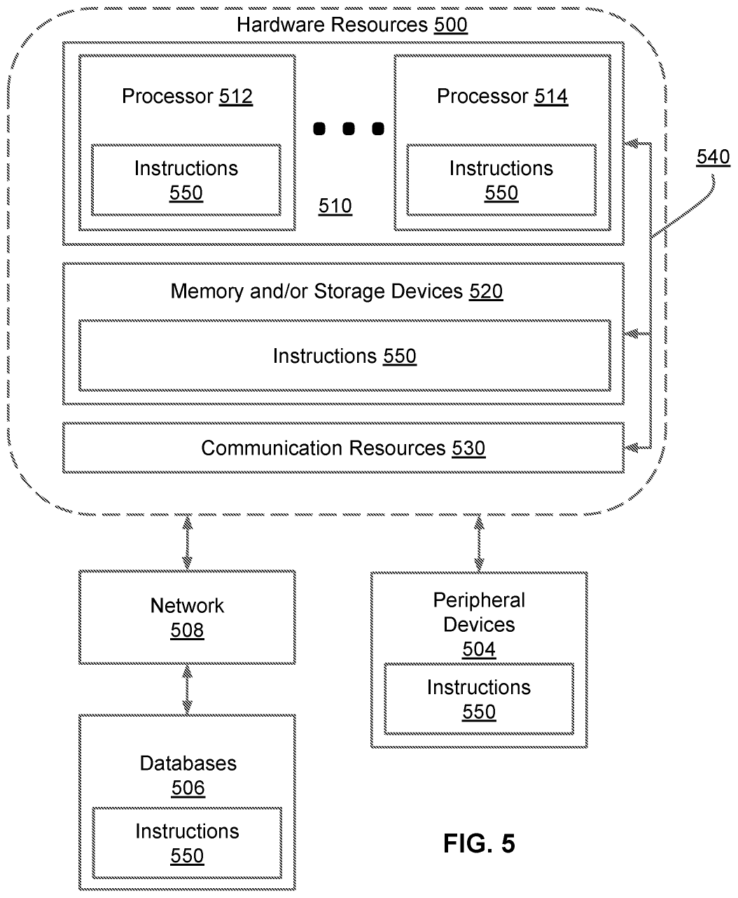

FIG. 5 is a block diagram illustrating a computing system and components, according to some example embodiments, able to read instructions from a machine-readable or computer-readable medium (e.g., a machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which are communicatively coupled via a bus 540.

The processors 510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 512 and a processor 514. The memory/storage devices 520 may include main memory, disk storage, or any suitable combination thereof.

The communication resources 530 may include interconnection and/or network interface components or other suitable devices to communicate with one or more peripheral devices 504 and/or one or more databases 506 via a network 508. For example, the communication resources 530 may include wired communication components (e.g., for coupling via a Universal Serial Bus (USB)), cellular communication components, Near Field Communication (NFC) components, Bluetooth® components (e.g., Bluetooth® Low Energy), Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 and/or the databases 506. Accordingly, the memory of processors 510, the memory/storage devices 520, the peripheral devices 504, and the databases 506 are examples of computer-readable and machine-readable media.

As used herein, the term “circuitry” may refer to, be part of, or include an Application Specific Integrated Circuit (ASIC), an electronic circuit, one or more processors, and/or memory (shared, dedicated, or group) that execute one more software or firmware programs, a combination logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a non-transitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general-purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

In an embodiment a method of video content linking may comprise multiple operations. An affiliate video linking system may receive user input indicating video content, a first timeframe within the video content, a first affiliate link, and a first shape information. The affiliate video linking system may form, based on the user input, affiliate video data. The affiliate video linking system may create, based on the user input, an indication of the affiliate video data. The affiliate video linking system may provide, to a device, the indication via a message. The affiliate video linking system may receive, based on the indication, a request to transmit the affiliate video data. The affiliate video linking system may transmit, to the device, the affiliate video data. The affiliate video linking system may record an indication of the transmitting as associated with an affiliate identified by the first affiliate link.

The embodiment may also include optional operations. The affiliate video linking system may record an indication that the first affiliate link was accessed. The affiliate video linking system may receive, based on the first affiliate link, a request for additional data from the device. The affiliate video linking system may transmit, based on the first affiliate link, a response customized with affiliate information. The affiliate video linking system may receive, based on the first affiliate link, a request for additional data from the device. The affiliate video linking system may record an indication that a computing resource associated with the first affiliate link was accessed. Receiving the user input may further comprise receiving the user input indicating a second timeframe within the video content, a second affiliate link, and a second shape information. Recording the indication of the transmitting may further comprise transmitting an indication of the affiliate to an affiliate server.

In another embodiment, a computer program product may comprise a computer-readable storage medium that stores instructions for execution by a processor to perform operations of an affiliate video rendering system, the operations, when executed by the processor, may perform a method. The method may include requesting, based on an indication of a computing resource and from the computing resource, affiliate video data. The method may include receiving the affiliate video data comprising video data and affiliate data. The method may include rendering, based on the video data, a video layer comprising video content. The method may include rendering, based on the affiliate data, and synchronized with the video layer, an affiliate link layer.

The embodiment may also include optional operations. The video data may comprise video content, a timeframe within the video content, an affiliate indication, and a shape information. The rendering the affiliate link layer may further comprises rendering, based on the timeframe and the shape information, a shape within the affiliate link layer synchronized with the video layer, and wherein the shape indicates an affiliate link. The method may include receiving user input indicating a request to access to an affiliate computing resource indicated by the affiliate link layer. The method may include requesting, from the affiliate computing resource, one or more resources. Rendering the affiliate link layer may further comprise rendering, based on timing data of the affiliate data, a first shape within the affiliate link layer. Rendering the affiliate link layer may further comprise rendering, based on first timing data of the affiliate data, a first shape within the affiliate link layer. Rendering the affiliate link layer may further comprise rendering, based on second timing data of the affiliate data, a second shape within the affiliate link layer. Rendering the affiliate link layer may further comprise rendering, based on timing data of the affiliate data, a first shape within the affiliate link layer. The first shape may indicate an affiliate link. The method may include transmitting, to a server, rendering information indicating that a first shape within the affiliate link layer was rendered.

In an embodiment, an apparatus of an affiliate video linking system may comprise memory and a processor. The memory may be configured to store an affiliate identifier. The processor may be configured to receive input indicating video content, a first timeframe within the video content, and a first graphical object information. The processor may be configured to form, based on the input and the affiliate identifier, affiliate video data. The processor may be configured to create, based on the affiliate video data, an indication of the affiliate video data. The processor may be configured to store at least a portion of the affiliate video data.

The embodiment may also include optional operations. The processor may be configured to provide, to a device, the indication via a message. The processor may be configured to receive, based on the indication, a request for the affiliate video data. The processor may be configured to transmit, to the device, the stored portion of the affiliate video data. The processor may be configured to record, as associated with an affiliate identified by the indication of the affiliate video data, an indication of the transmitting of the stored portion. Creating the indication of the affiliate video data may further comprise creating an indication of resource for video data and an indication of a resource for affiliate data. The processor may be configured to record an indication that the indication of the affiliate video data from an affiliate link layer was accessed. Receiving the input indicating the video content may further comprise receiving the input indicating a second timeframe within the video content, and a second graphical object information. The first graphical object information may comprise polygon data.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/aspects/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

What is claimed:

1. A method of video content linking comprising:
receiving user input indicating video content, a first timeframe within the video content, a first affiliate link, and a first shape information;
forming, based on the user input, affiliate video data;
creating, based on the user input, an indication of the affiliate video data;
providing, to a device, the indication via a message;
receiving, based on the indication, a request to transmit the affiliate video data;
transmitting, to the device, the affiliate video data; and
recording an indication of the transmitting as associated with an affiliate identified by the first affiliate link.

2. The method of claim 1, further comprising recording an indication that the first affiliate link was accessed.

3. The method of claim 1, further comprising:
receiving, based on the first affiliate link, a request for additional data from the device; and
transmitting, based on the first affiliate link, a response customized with affiliate information.

4. The method of claim 1, further comprising:
receiving, based on the first affiliate link, a request for additional data from the device; and
recording an indication that a computing resource associated with the first affiliate link was accessed.

5. The method of claim 1, wherein receiving the user input further comprises receiving the user input indicating a second timeframe within the video content, a second affiliate link, and a second shape information.

6. The method of claim 1, wherein recording the indication of the transmitting further comprises transmitting an indication of the affiliate to an affiliate server.

7. A computer program product comprising a computer-readable storage medium that stores instructions for execution by a processor to perform operations of an affiliate video rendering system, the operations, when executed by the processor, to perform a method, the method comprising:
requesting, based on an indication of a computing resource and from the computing resource, affiliate video data;
receiving the affiliate video data comprising video data and affiliate data;
rendering, based on the video data, a video layer comprising video content; and
rendering, based on the affiliate data and synchronized with the video layer, an affiliate link layer.

8. The computer program product of claim 7, wherein the video data comprises video content, a timeframe within the video content, an affiliate indication, and a shape information.

9. The computer program product of claim 8, wherein the rendering the affiliate link layer further comprises rendering, based on the timeframe and the shape information, a shape within the affiliate link layer synchronized with the video layer, and wherein the shape indicates an affiliate link.

10. The computer program product of claim 7, the method further comprising:
receiving user input indicating a request to access to an affiliate computing resource indicated by the affiliate link layer; and
requesting, from the affiliate computing resource, one or more resources.

11. The computer program product of claim 7, wherein rendering the affiliate link layer further comprises rendering, based on timing data of the affiliate data, a first shape within the affiliate link layer.

12. The computer program product of claim 7, wherein rendering the affiliate link layer further comprises:
rendering, based on first timing data of the affiliate data, a first shape within the affiliate link layer; and
rendering, based on second timing data of the affiliate data, a second shape within the affiliate link layer.

13. The computer program product of claim 7, wherein rendering the affiliate link layer further comprises:
rendering, based on timing data of the affiliate data, a first shape within the affiliate link layer, and
wherein the first shape indicates an affiliate link.

14. The computer program product of claim 7, the method further comprising transmitting, to a server, rendering information indicating that a first shape within the affiliate link layer was rendered.

15. An apparatus of an affiliate video linking system, comprising:
memory configured to store an affiliate identifier; and
a processor configured to:
receive input indicating video content, a first timeframe within the video content, and a first graphical object information;
form, based on the input and the affiliate identifier, affiliate video data;
create, based on the affiliate video data, an indication of the affiliate video data; and
store at least a portion of the affiliate video data.

16. The apparatus of claim 15, wherein the processor is further configured to:
provide, to a device, the indication via a message;
receive, based on the indication, a request for the affiliate video data;
transmit, to the device, the stored portion of the affiliate video data; and
record, as associated with an affiliate identified by the indication of the affiliate video data, an indication of the transmitting of the stored portion.

17. The apparatus of claim 15, wherein to create the indication of the affiliate video data further comprises to create an indication of resource for video data and an indication of a resource for affiliate data.

18. The apparatus of claim 15, the processor is further configured to record an indication that the indication of the affiliate video data from an affiliate link layer was accessed.

19. The apparatus of claim 15, wherein to receive the input indicating the video content further comprises to receive the input indicating a second timeframe within the video content, and a second graphical object information.

20. The apparatus of claim 15, wherein the first graphical object information comprises polygon data.
